(19) United States
(12) Patent Application Publication
(10) Pub. No.: US 2013/0091331 A1
(43) Pub. Date: Apr. 11, 2013

(54) METHODS, APPARATUS, AND ARTICLES OF MANUFACTURE TO MANAGE MEMORY

(71) Applicants: Iulian Moraru, Pittsburgh, PA (US); Niraj Tolia, Sunnyvale, CA (US); Nathan Lorenzo Binkert, Redwood City, CA (US)

(72) Inventors: Iulian Moraru, Pittsburgh, PA (US); Niraj Tolia, Sunnyvale, CA (US); Nathan Lorenzo Binkert, Redwood City, CA (US)

(21) Appl. No.: 13/270,785

(22) Filed: Oct. 11, 2011

(51) Int. Cl. G06F 12/08

(52) U.S. Cl. 711/143; 711/E12.008; 711/E12.026

(57) ABSTRACT

Methods, apparatus, and articles of manufacture to manage memory are disclosed. An example method includes mapping a cache memory to a random access memory, incrementing a counter in response to a data write to a cache line of the cache memory, decrementing the counter in response to a write-back of the data from the cache line, and committing the data to the RAM when the counter is equal to a threshold.

### BACKGROUND

Modern microprocessors include cache memories to reduce access latency for data to be used by the processing core(s). The cache memories are managed by a cache replacement policy so that, once full, portions of the cache memory are replaced by other data.

### BRIEF DESCRIPTION OF THE DRAWINGS

FIG. 1 is a block diagram of an example processor constructed in accordance with the teachings of this disclosure.

FIG. 2 is a more detailed block diagram of the example memory manager of FIG. 1.

FIG. 3 illustrates an example cache tag to store a counter identifier in accordance with the teachings of this disclosure.

FIG. 4 is pseudocode representative of example instructions which, when executed by a processor, cause the processor to perform a data transaction and commit a data transaction to non-volatile memory.

FIGS. 5A-5F illustrate an example process to commit data transactions to non-volatile memory using a processor counter.

FIGS. 6A-6F illustrate another example process to commit data transactions to non-volatile memory using a processor counter and shadow paging.

FIGS. 7A-7F illustrate another example process to commit data transactions to non-volatile memory using a processor counter and memory pointers.

FIG. 8 is a flowchart representative of example machine readable instructions to implement the example processor and the example memory manager of FIG. 1 to perform data transactions.

FIG. 9 is a flowchart representative of example machine readable instructions to implement the example processor and the example memory manager of FIG. 1 to commit a data transaction to non-volatile memory.

FIG. 10 is a flowchart representative of example machine readable instructions to implement the example processor and an example operating system to provide an interface to a computer application for operating on data in a non-volatile memory.

FIG. 11 is a diagram of an example processor system that may be used to implement the example processor and/or the non-volatile memory of FIGS. 1-3 to commit data transactions to the non-volatile memory.

### DETAILED DESCRIPTION

Non-volatile random access memory (RAM) (NVRAM) technologies (e.g., memristors, phase-change memory (PCM), spin-transfer torque magnetic RAM, etc.) are improving and may eventually have access latencies similar to those of dynamic RAM (DRAM), which is volatile. As used herein, non-volatile memory refers to memory which retains its state in the event of a loss of power to the memory, while volatile memory refers to memory which does not retain its state when power is lost. To take advantage of improved non-volatile memories, NVRAM may be used similarly to DRAM by, for example, placing NVRAM on the memory bus of a processing system to allow fast access through processor (e.g., central processing unit (CPU)) loads and stores.

Processor caches improve processor performance when accessing memory by caching reads and writes, because processor caches are substantially faster than RAM in terms of access latency for the processor. However, processors do not offer guarantees as to when or if data in the processor caches will be written to RAM, or in which order the writes occur. For volatile memory the lack of guarantees does not usually affect the correctness of computations. However, when modifying persistent data (e.g., in non-volatile memories), some application programmers rely on guarantees that data stored or updated in a processor cache will eventually be stored in the non-volatile memory, and that the data stores and/or updates will be stored in the non-volatile memory in a defined order. In some cases, application programmers may rely on groups of stores and/or updates being stored atomically (e.g., data writes to memory of an atomic transaction are either all applied to persistent data or none are, data writes to memory of an atomic transaction appear to be done at the same time to other processes or transactions). These guarantees are used to ensure the consistency of persistent data in the face of failures (e.g., power failures, hardware failures, application crashes, etc.). Failure to provide the storing and/or ordering may cause errors in the processing system up to and including catastrophic failures.

A known method to providing ordering and atomicity guarantees include forcing processor caches to be flushed to provide ordering and atomicity. Processor cache flushing includes forcing a write-back of data in the cache to the memory. As used herein, a “data write” or “cache write” refers to writing data to one or more lines of a processor cache memory, while a “data write-back” or simply “write-back” refers to a transfer or write of the data in the processor cache memory to a location in the internal memory (e.g., RAM, NVRAM). Cache flushing is slow and is an inefficient use of the processor cache.

Another known method to provide ordering and atomicity guarantees for non-volatile memory includes the use of “epoch barriers.” In such a method, programs can issue a special write barrier, called an “epoch barrier.” The writes issued between two such epoch barriers belong to the same epoch. Epochs are naturally ordered by their temporal occurrence. Before a write-back from an epoch is to be written-back from the cache to non-volatile memory, the processor checks to make sure that all the write-backs from all previous epochs have already been applied to the non-volatile memory. The primary disadvantage of epoch barriers is that this method requires substantial modifications to the processor. Specifically, using epoch barriers depends on a hardware mechanism for searching through cache lines to find all the updates from previous epochs, and it requires changes to the cache line replacement algorithm (or policy). The cache line replacement algorithm determines which cache lines are to be replaced when data is to be input to a processor cache from memory. Such algorithm modifications are also likely to adversely impact the performance of the processor. Additionally, it is not clear whether epoch barriers can be adapted to work with multi-core processors and/or multitasking operating systems.

To overcome the above shortcomings of known methods, example methods, apparatus, and articles of manufacture disclosed herein use a processor provided with a plurality of counters, which are assigned by an operating system and/or a user application to data transactions and count a number of cache lines to be stored to non-volatile memory before the data transaction is to be committed. Some such example methods, apparatus, and articles of manufacture use the counters to provide atomicity and/or ordering of data transactions when the committing data transactions to non-volatile memory.

Some example methods, apparatus, and articles of manufacture disclosed herein use shadow paging to provide atomicity and/or ordering to data transactions. In some such examples, a processor creates a shadow page in the non-volatile memory. Persistent data associated with a data transaction is mapped in an address space of a process as read-only. When the processor first writes to a persistent page to write-back data associated with a data transaction, an operating system copies the persistent page to create a shadow page and maps the shadow page in the address space of the process, in the place of the original. The write-back is performed in the shadow page, as well as all subsequent accesses (e.g., reads from and/or writes to the address space of the process). If the write-backs (e.g., all of the write-backs) for the data transaction are successful (e.g., successfully copy data to the shadow page), the original page may be discarded and the shadow page takes its place. In some examples, an operating system and/or user application(s) can implement atomicity and ordering by using the counters in other ways.

Some other example methods, apparatus, and/or articles of manufacture disclosed herein provide atomicity and/or ordering to data transactions by writing-back data to the end of a list of records, where each record in the list includes a pointer to a subsequent record. When the write-backs (e.g., all write-backs) associated with the data transaction have been completed, the last record in the list is updated to include a pointer to the record including the written-back data associated with the data transaction, thereby causing the written-back data to be the last record in the list. While example methods, apparatus, and articles of manufacture that provide atomicity and/or ordering to data transactions by using counters in a processor are disclosed herein, these are not the only methods to provide ordering and/or atomicity to data transactions using counters.

As used herein, a “data transaction” refers to a group of updates (e.g., writes and/or write-backs) to one or more lines of main memory. Committing a data transaction refers to causing updates to the memory to be recognized (e.g., to other processes and/or applications) as persistent and durable. In the case of a non-volatile main memory, successfully committing a data transaction will cause the updated data from the data transaction to be recoverable from the main memory in the event of a power failure (unless later overwritten). In some examples, committing a transaction is performed using shadow pages. In some other examples, committing the transaction occurs in the original page. Some disclosed example methods, apparatus, and/or articles of manufacture disclosed herein permit a program to specify if committing a data transaction is to take place immediately, at some time in the future before a subsequent transaction is committed (e.g., before any later transaction is committed), or at some time in the future with no ordering requirements.

In some example methods, apparatus, and/or articles of manufacture using shadow paging, the entire content of a data transaction's shadow page is to be in memory before a processor can commit the data transaction. In some examples in which a data transaction is to be committed immediately, an operating system forces cache line flushes for all the pages in the data transaction. In other examples in which committing the data transaction occurs at a later time, the operating system commits the data transaction after the processor notifies the operating system that all the cache lines written as a result of the data transaction have been flushed (e.g., due to normal cache line replacement).

In some example methods, apparatus, and/or articles of manufacture disclosed herein, the processor is provided with a set of counters to be selectively associated with transactions. In some such examples, an operating system associates a data transaction with a respective counter in each level of the processor caches and provides the processor with an identifier of the counter to be used to monitor writes and write-backs occurring as a result of the data transaction.

In some examples, the processor and/or the operating system include a memory manager, which increments the counter associated with the transaction for a processor cache for every cache line written from within the transaction in that processor cache. In some such examples, the memory manager further tags the written cache line with the identifier of the counter. In some examples, the processor checks the tag of each replaced (e.g., flushed) cache line for a counter identifier and decrements the counter corresponding to the identifier. When a counter associated with a data transaction reaches a threshold (e.g., 0 in most cases, signifying a completed data transaction), the processor notifies the operating system (e.g., via an interrupt, operating system polling, user application polling, etc.). In some such examples, the threshold value is representative of zero cache lines storing data associated with a data transaction that has not been written-back to the NVRAM. In some examples, the operating system commits a data transaction when the following conditions are met: the data transaction has ended, the counters associated with the data transaction are equal to the threshold value, and the ordering constraints are satisfied (e.g., all transactions specified by a program to commit before the data transaction to be committed have already been committed).

In some examples, the processor assigns the counters. In some other examples, the operating system assigns the counters. In some such examples, the operating system identifies to the processor which of the plurality of counters to use at the start of each transaction. In some examples, the processor is provided with a number of counters in each cache level equal to a number of pages in that cache level, plus one.

In contrast to known methods of providing atomicity and ordering for non-volatile memory, example methods, apparatus, and/or articles of manufacture disclosed herein reduce or eliminate flushing of cache lines beyond the normal cache line replacement policy, thereby improving performance of the processor. Additionally, example methods, apparatus, and articles of manufacture disclosed herein implement fewer and/or less extensive modifications to processor hardware and/or memory than known methods. Example methods, apparatus, and/or articles of manufacture disclosed herein use processor operations that run in constant time and can be implemented efficiently, thereby reducing or avoiding latency overhead. Additionally, example methods, apparatus, and/or articles of manufacture disclosed herein may be used in combination with multi-core processors and/or multitasking operating systems because the operating system manages the counters and sets the appropriate counters to be used whenever a new data transaction is scheduled to run.

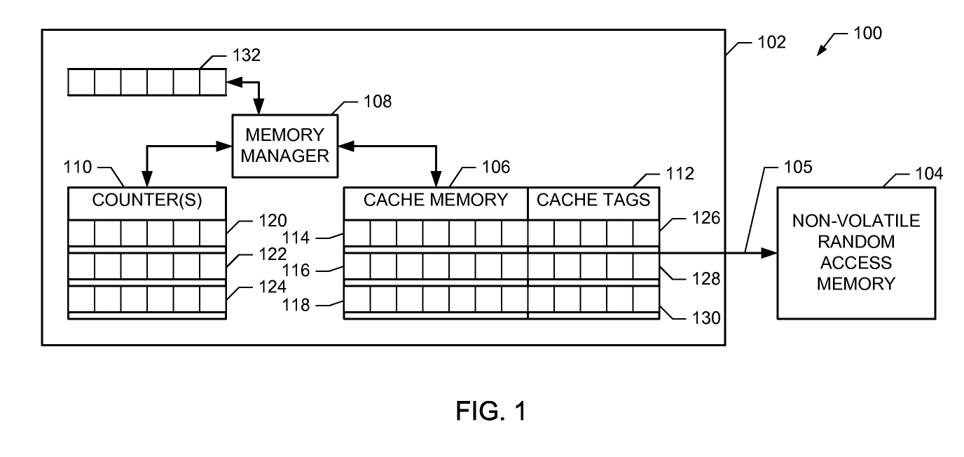

FIG. 1 is a block diagram of an example computing system 100. The example computing system 100 of FIG. 1 may be implemented by any type of computing device such as a personal computer, a server, a tablet computer, a cell phone, and/or any other past, present, and/or future type of computing system. The example computing system 100 includes a processor 102 and a non-volatile random access memory (NVRAM) 104. The example processor 102 of FIG. 1 retrieves data from and/or stores data to the NVRAM 104. The NVRAM 104 stores data persistently (e.g., retains stored data in the event of a failure such as a power loss or application failure). In the example of FIG. 1, the NVRAM 104 is coupled to the processor 102 via a bus 105, to which other memories and/or system components may be coupled.

In the example of FIG. 1, the processor 102 includes a cache memory 106, a memory manager 108, a set of counters 110, and cache tags 112. The cache memory 106 of the illustrated example is divided into cache lines 114, 116, 118. The cache memory 106 of the illustrated example is allocated to transactions and/or processes in the lines 114, 116, 118. The example cache memory 106 of FIG. 1 has multiple levels (e.g., level 1 (L1), level 2 (L2), level 3 (L3)). Each level has a total size (e.g., 512 kilobyte (KB) L1 cache, 8 megabyte (MB) L3 cache, etc.). In some examples, each of the cache lines 114, 116, 118 also has an equal size (e.g., 64 bytes). For instance, an example 8 MB (8,388,608 bytes) L3 cache memory may have 131,072 lines, each 64 bytes long.

The example set of counters 110 of FIG. 1 includes multiple counters 120, 122, 124. In some examples (e.g., in which shadow paging is used to provide atomicity), the number of counters 120, 122, 124 is equal to the number of lines (e.g., 131,072) in the cache memory 106, plus one (e.g., 131,073). The example memory manager 108 of FIG. 1 selectively assigns counters 120, 122, 124 to data transactions that are associated with pages of the cache memory 106. In some examples, a counter 120, 122, 124 may be assigned to a data transaction that is allocated more than one cache line 114, 116, 118 of the cache memory 106. In these examples, each of the counters 120, 122, 124 is able to count up to the total number of cache lines 114, 116, 118 in the cache memory 106. As an example, for an 8 MB-cache memory having 64-byte cache lines, there are 131,072 (2¹⁷) cache lines and each counter 120, 122, 124 has 17 bits to enable the counters 120, 122, 124 to count up to the number of cache lines 114, 116, 118 in the cache memory 108. The set of counters 110 of the illustrated example has one counter more than the number of lines 114, 116, 118. Was this additional counter not present, if each data transaction used one page of the cache memory 106, then at least one line would be flushed (e.g., one transaction would be committed) before another (e.g., the next) transaction could be allocated memory in the cache memory 106. Such flushing can be computationally expensive and is, thus, undesirable.

In some examples, the set of counters 110 is implemented using space in the cache memory 106 (e.g., using cache lines 114, 116, 118). In some other examples, the set of counters is implemented using dedicated space on the processor die. This dedicated space may be in place of one or more of the cache line(s) 114, 116, 118 or may exist in addition to the cache line(s) 114, 116, 118.

The example cache tags 112 of FIG. 1 include multiple cache tags 126, 128, 130, which are implemented as additional bits of the respective cache lines 114, 116, 118. Each of the example cache tags 126, 128, 130 of FIG. 1 corresponds to at least one of the cache lines 114, 116, 118, and includes multiple bits to store information about the data in the respective cache line(s) 114, 116, 118. In particular, the example cache tags 126, 128, 130 include information about the locations in NVRAM 104 to which the cache lines 114, 116, 118 are mapped (e.g., metadata identifying what information in NVRAM 104 is contained in the cache memory 106), a counter identifier (e.g., metadata identifying which counter 120, 122, 124 in the set of counters 110 is assigned to the cache line(s) 114, 116, 118), a core identifier to identify which core in a multi-core processor is using the information in the cache line(s) 114, 116, 118, and/or other information about the cache memory.

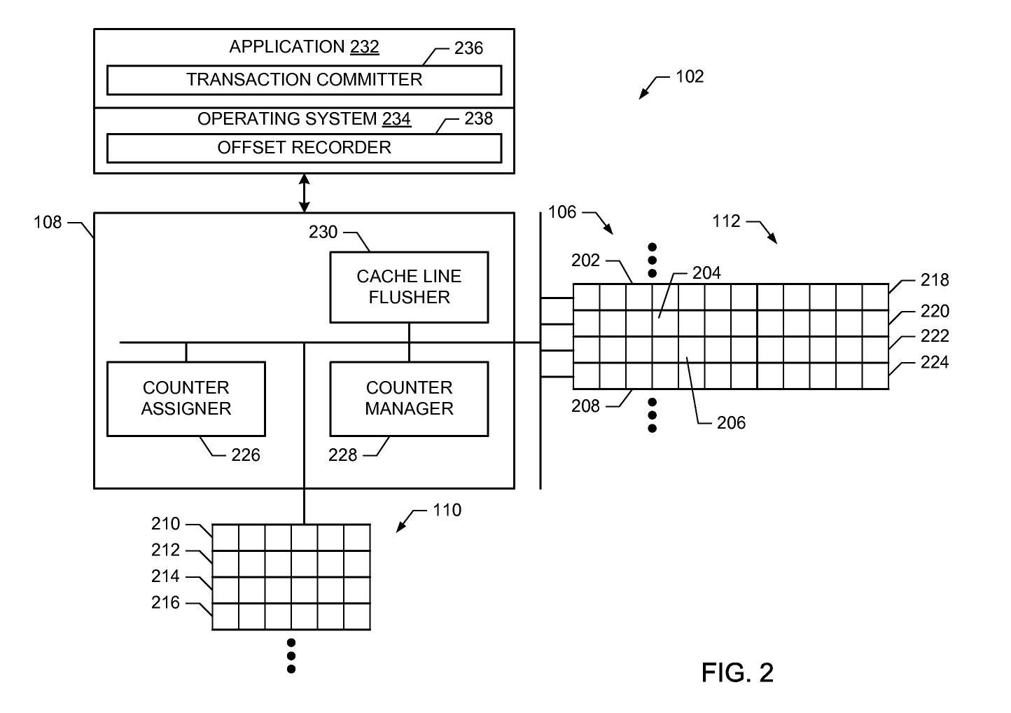

The example memory manager 108 illustrated in FIG. 1 manages the example cache memory 106 and the counters 110 to commit transactions to the NVRAM 104. In particular, the example memory manager 108 assigns counter(s) 120, 122, 124 to transactions. The example memory manager 108 also tags cache line(s) 114, 116, 118 (e.g., writes identifying data to corresponding cache tag(s) 126, 128, 130) with an identifier of an assigned counter and/or increments the assigned counter(s) 120, 122, 124 when a corresponding transaction writes to a clean cache line(s) 114, 116, 118. The example memory manager 108 also checks the cache tag(s) 126, 128, 130 for counter identifier(s) and/or decrements the assigned counter(s) 120, 122, 124 when cache line(s) are flushed (e.g., replaced as part of a normal cache replacement policy, force flushed, etc.). The example memory manager 108 also commits transactions from the cache memory 106 to the NVRAM 104. The example memory manager 108 of FIG. 1 may be implemented in the processor 102, as a separate circuit on or off the processor die, and/or as a portion of an operation system via tangible machine readable instructions stored on a machine readable medium. A more detailed block diagram of the example memory manager 108 of FIG. 1 is described below with reference to FIG. 2.

In some examples, the processor 102 includes the same or less counters than the number of cache lines. While die space limitations on the processor 102 may make such a large number of counters prohibitive in some examples, smaller numbers of counters may risk running out of counters during operation if, for example, many applications each perform many small, atomic groups of updates. Therefore, in some examples the processor includes a virtual counter 132. The example virtual counter 132 of FIG. 1 has a value of zero. When there are no more free counters, the memory manager 108 will use the virtual counter 132 as the assigned counter. If the processor 102 is to write back data to the NVRAM 104 when the memory manager 108 has assigned the virtual counter 132, the data write-back will be performed as a non-temporal write. A non-temporal write is a data write that bypasses the cache memory 106 and data is written directly to the NVRAM 104. Therefore, the example processor 102 avoids adversely affecting the correctness of data transactions by forcing a flush of an atomic data transaction when the set of counter(s) 110 is occupied.

FIG. 2 is a more detailed block diagram of the example memory manager 108 of FIG. 1. The example memory manager 108 is coupled to the cache memory 106. The cache memory 106 has a plurality of cache lines 202-208, which may be organized into multiple levels (e.g., L1, L2, and/or L3). The example memory manager 108 is further communicatively coupled to the set of counter(s) 110, which includes counters 210, 212, 214, 216. The example memory manager 108 of FIG. 2 is also communicatively coupled to the cache tags 112, which includes cache tags 218, 220, 222, 224. Each of the example cache tags 218, 220, 222, 224 corresponds to one of the example cache lines 202-208.

In the example of FIG. 2, the memory manager 108 includes a counter assigner 226, a counter manager 228, and a cache line flusher 230. The example counter assigner 226, the example counter manager 228, and the example cache line flusher 230 of FIG. 2 are implemented in a processor such as a multi-core processor having a multi-level cache memory. In some examples, however, one or more of the example counter assigner 226, the example counter manager 228, and the example cache line flusher 230 are implemented as a circuit separate from the processor 102 (e.g., a separate chip, an assembly) as a separate circuit on the processor die, and/or as a part of an operating system executing on the processor 102.

The example counter assigner 226 of FIG. 2 selects a counter 210-216 from the set of counters 110 and assigns the selected counter 210-216 to a data transaction. In some examples, the counters 210-216 are marked as free (e.g., not currently in use by a data transaction) or occupied (e.g., currently in use by a data transaction). For example, the most significant bit (MSB) or the least significant bit (LSB) of each of the example counters 210-216 may indicate whether that counter 210-216 is free or occupied. Additionally or alternatively, the memory manager 108 may maintain an index for the set of counters 110 to identify a counter 210-216 as free or occupied.

The example counter manager 228 of FIG. 2 manages the counters 210-216 based on the assignment of the counters 210-216 to data transactions. When a data transaction is started by an application (e.g., via an operating system running on the processor 102 of FIG. 1, by calling a special processor instruction, etc.), the counter manager 228 receives the selection of one of the counters 210-216 (e.g., the counter 210) from the counter assigner 226. When the data transaction writes data to one or more of the cache lines 202-208, the counter manager 228 tags the corresponding cache line(s) 202-208 with an identifier of the counter 210 and increments the counter 210. The example counter manager 228 of FIG. 2 writes the identifier of the counter 210 to a designated portion of the cache tag(s) 218-224 associated with the cache line(s) 202-208 to which the data is written. As a result of incrementing the counter 210, the counter 210 reflects that there is one additional “dirty” line associated with the data transaction in the cache memory 106. A “dirty” cache line is a cache line that may have data different than the corresponding line in the main memory (e.g., the NVRAM 104). Conversely, when the data transaction writes-back data from a cache line 202-208 to the NVRAM 104, the counter manager reads a cache tag 218-224 from the corresponding cache line 202-208 that is being written-back to determine which of the counters 210-216 is assigned to the cache line 202-208, and decrements the counter 210 based on the counter identifier in the tag 218-224. Therefore, the example counters 210-216 represent the number of cache lines 202-208 for the respective data transactions that have data that have not been written back to NVRAM 104 (e.g., the number of dirty cache lines).

The example cache line flusher 230 of FIG. 2 flushes (e.g., replaces, writes-back to main memory) the contents of the cache lines 202-208 according to a cache line replacement policy. The example cache line flusher 230 may use any one or more past, present, and/or future cache line replacement algorithms to determine which of the cache lines 202-208 is to be flushed when data is to be loaded into the cache 106 from memory.

The example memory manager 108 of FIG. 2 is in communication with an application 232 via an operating system 234. The example application 232 includes a transaction committer 236 to commit a transaction to memory. In some examples, the transaction committer commits a transaction when the transaction committer 236 has determined that conditions exist that permit the application 232 to commit the transaction. Example conditions include: a counter assigned to the data transaction is equal to a target or threshold value (e.g., 0), the data transaction is completed (e.g., all instructions for the data transaction have been executed and data for the data transaction has been written to a cache line 202-208 and/or to NVRAM 104), any ordering requirements specified by the application for the data transaction are fulfilled (e.g., data transactions that the application requires to be committed before the data transaction under consideration are committed), and/or other conditions. If the conditions have been met, the example transaction committer 236 of FIG. 2 commits the data transaction to NVRAM 104. In examples in which the memory manager 108 uses shadow paging, the example transaction committer 236 commits the data transaction to a shadow page and then updates an application memory mapping to use the shadow page instead of the original page.

In some examples, the processor 102, the memory manager 108, an operating system, and/or another actor may cause a forced flush of a data transaction to commit the data transaction to NVRAM 104. Such forced flushes can occur if, for example, the cache memory 106 is full (e.g., all lines of the cache memory 106 are allocated to applications) and a data write is to write data to a cache line 202-208.

The example application 232 further includes an offset recorder 238. The example offset recorder 238 of FIG. 2 determines when a data transaction writes to a cache line 202-208 that is not the first cache line of a page. Instead of flushing the entire page when less than the entire page can be flushed to commit the data transaction associated with the page, the offset recorder 238 enables the transaction committer 236 to reduce the number of cache lines 202-208 that are flushed, thereby reducing a performance penalty incurred by the forced flushing. For example, when a data transaction performs a write to such a cache line 202-208, the offset recorder 238 stores the offset of the written cache line 202-208. If the processor 102 forces a flush of the data transaction, the offset recorder 238 causes the transaction committer 236 to begin flushing at the offset, or at the first cache line 202-208 that includes data to be written-back to NVRAM 104, rather than flushing a large block of cache lines 202-208.

In some examples, the processor 102 supports a set of instructions for programs and/or an operating system to interact with the counters 210-216. For example, a data transaction may contain data writes issued between two calls to a sgroup instruction (e.g., on one thread of execution of instructions). The sgroup instruction signals the start of a data transaction. When the example instruction sgroup is called, the counter assigner 226 of the illustrated example selects a free counter to be used for a data transaction.

The illustrated example provides an scheck instruction to enable verification of counter values. For example, an application may retrieve a counter identifier from a processor register and use a scheck instruction to verify the value of the counter. When scheck is called for a counter 210-216 whose value has reached zero, that counter 210-216 is marked as free (e.g., clean). The selected counter 210-216 is incremented when a data transaction writes data to (e.g., dirties) a cache line 202-208, and is decremented when a cache line 202-208 tagged with the identifier of the counter 210-216 is written-back to the NVRAM 104 (e.g., by a write-back during normal cache line replacement, as a result of a forced cache line flush (clflush) call, etc.). A store to a cache line 202-208 tagged with an identifier of a given one of the counters 210-216 (e.g., the counter 210) will not modify the values of any of the counters (e.g., counters 210-216). In some examples, the foregoing procedure(s) are performed when data transactions are to be ordered (e.g., a transaction is only committed after all previous groups have been committed). In some such examples, the operating system saves and/or restores the register(s) containing the identifier of the current counter being used for a data transaction when a thread is preempted and/or when a thread is scheduled for execution, respectively.

An inclusive cache memory is hereby defined to be a cache that writes data retrieved from main memory (e.g., the NVRAM 104) to all levels of the cache. In a multi-core processor in which the last level caches (e.g., L2, L3 cache(s)) are not inclusive (e.g., data in the cache memory 106 only exists in one level of the cache memory 106), each core of the processor 102 maintains a separate set of counters in its L1 cache, in a direct-mapped structure. The cache tags associated with the cache memory 106 in the L1 cache are extended with space for a counter identifier. The cache tags in shared caches (e.g., L2 cache, L3 cache, etc.) are also extended, but are provided with space for both a counter identifier and an identifier of the processing core. When a processor core writes data to a cache line 202-208 (e.g., dirties a cache line 202-208), the example memory manager 108 increments the counter 210-216 assigned to the cache line 202-208 and tags the cache line 202-208 with the identifier of the counter 210-216. When the data in a cache line 202-208 is written-back to the example NVRAM 104, the memory manager 108 determines the identifier of the counter from the cache tag for the cache line 202-208 and decrements the counter corresponding to the determined identifier. In some examples, the decrement of the counter 210-216 occurs after the write-back is acknowledged (e.g., by a memory controller, by the NVRAM 104, etc.). If the example data write(s) and/or data write-back(s) occur in a level of cache other than L1 in a multi-core processor, the memory manager 108 of the illustrated example increments and/or decrements the counter(s) corresponding to that level's cache line(s) via the core that owns the counter corresponding to the cache lines. This core may be identified, for example, in the cache tags 218-224.

In some examples, a special case occurs when a cache line 202 is pulled into a private (e.g., L1) cache of a first core different than a second core that owns the counter 210 associated with the cache line 202. In such examples, the cache line 202 is cleaned from all the caches accessible from the first core and sent clean to the second core. This means that the first core no longer keeps track of the cache line 210. While in some instances this may cause overhead for applications with such an access pattern, this overhead is acceptable because applications already try to avoid expensive cache line “pingponging.” However, such a situation can also occur as a result of a thread of execution being migrated to a different core. In such examples, the user application does not know that it is to keep track of an additional counter for its current group of data writes and/or write-backs (e.g., the group is considered committed to NVRAM once all counters associated with it reach zero). In such examples, the operating system notifies the application (e.g., through a signal). While this process could make working with counters more awkward for programmers, it is also likely to be an uncommon situation, since operating system schedulers try to maintain core affinity, and applications may even ask that this be enforced.

In the illustrated example, when an application tries to read the value of a counter maintained by a core other than the one on which it is running, that counter value is brought in through the cache subsystem, just as with normal memory content (e.g., the counters are memory mapped with read access).

In some examples in which the processor 102 has inclusive shared last level caches, the counters 210-216 keep track of the cache lines 202-208 in the last level (e.g., L2, L3) of the cache memory 106. As a result, in such examples the processor 102 reduces or avoids churn in smaller caches and allows an implementation in which the counters 210-216 are global and are stored in a larger, higher cache level. Such an example processor 102 may utilize simpler logic to implement the example memory manager 108 to manage the set of counter(s) 110.

The example processors of such examples also allow more counters 210-216 to be used because the higher level(s) of the cache memory 106 are typically about two orders of magnitude larger than the first level caches (e.g., L1) in some processors 102. While reading values from the counters 210-216 results in higher latency, this added latency is small compared to the latencies of frequent main memory (e.g., NVRAM, RAM) accesses for data-intensive applications.

An example multi-core processor 102 has 8192 counters for each core, with one byte allocated for each counter. This arrangement employs 25% of the space available in a 32 KB L1 cache if inclusive caches are not available. In such an example, each counter may count up to 255 cache lines. In some examples, the processor 102 includes one or more double counters that combine the space of two or more normal counters to be able to count up to the total number of cache lines 114, 116, 118 in the cache memory 106. In some such examples, when a normal counter (e.g., one byte) would reach its counting limit, the memory manager 108 upgrades that counter to a double counter (e.g., two bytes). Additionally or alternatively, the memory manager 108 may treat subsequent writes for the data transaction as non-cacheable (e.g., non-temporal, writing directly to the NVRAM 104 and bypassing the cache memory 106). In an example processor 102 having 8192 counters, the cache line tags are extended by 13 to 16 bits (e.g., 13 bits for a single core, up to 16 bits to also hold a core identifier). For an example quad core processor with 32 KB private L1-D caches, 256 KB private L2 caches and an 8 MB fully-shared inclusive L3 cache (e.g., a Core i7 CPU) the set of counters 110 and the extension of the cache line tags would use about 264 Kb of space overhead, which is incurred exclusively on the L3 cache (e.g., a 3.2% space overhead).

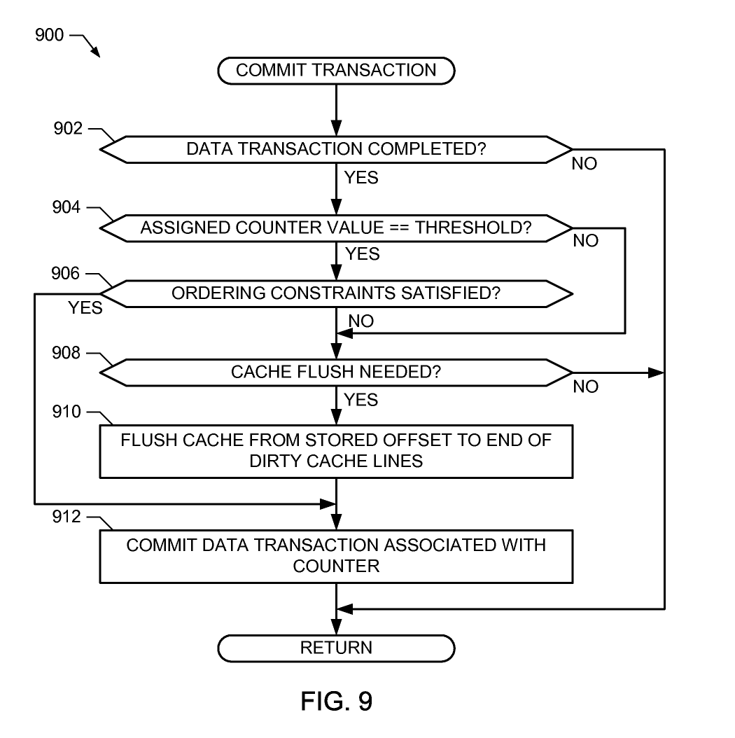

While the example counter assigner 226, the example counter manager 228, the example cache line flusher 230 and, more generally, the example memory manager 108 of FIG. 2 are illustrated as part of the processor 102, any one or more of the example counter assigner 226, the example counter manager 228, the example cache line flusher 230 and, more generally, the example memory manager 108 may be implemented as a separate circuit either on the processor die or off chip, and/or using machine readable instructions implemented as a part of an operating system for execution on the processor 102. A flowchart representative of example machine readable instructions is described in FIG. 9 to illustrate such an example implementation.

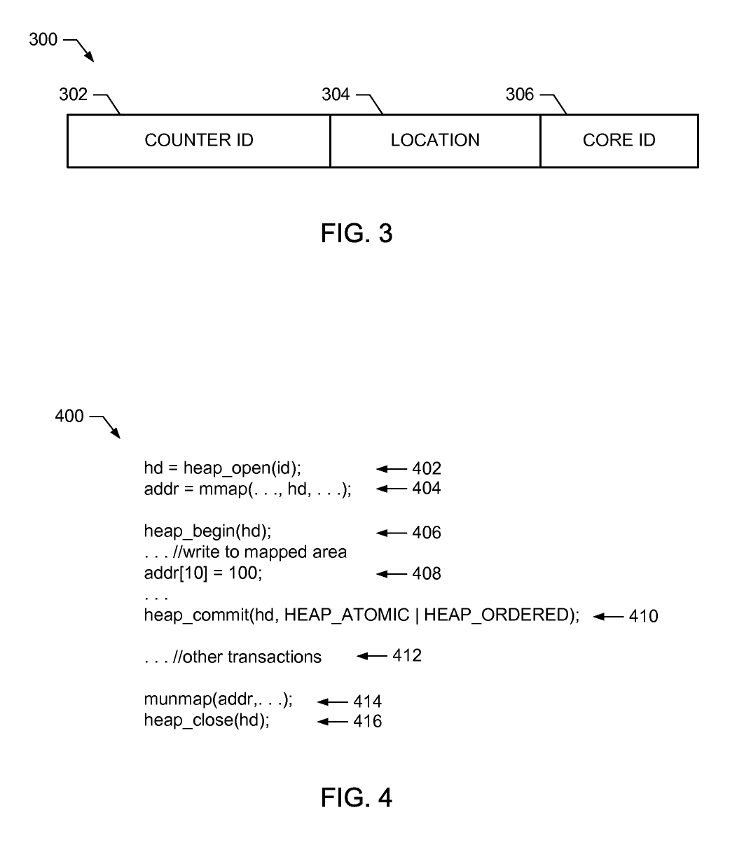

FIG. 3 illustrates an example cache tag 300 to store a counter identifier 302. The example cache tag 300 of FIG. 3 may be used to implement the example cache tags 218-224 of FIG. 2 to index cache lines 202-208 in a cache memory 106. In the example of FIG. 3, the cache tag 300 includes a counter identifier 302, a location 304, and a core identifier 306. The counter identifier 302 is populated by the counter manager 228 of FIG. 2 when data is written into a cache line 202-208 corresponding to the cache tag 300. For example, the counter manager 228 writes the counter identifier of a counter 218-224 that is assigned to the data transaction performing the write to the cache line 202-208.

The example location 304 is similar or identical to cache tags, which identify the data in the cache line(s) and the locations of the corresponding data in RAM (e.g., NVRAM).

The core identifier 306 of the illustrated example stores an identifier of a processing core in a multi-core processor. The memory manager 108 may reference the core identifier 306 to determine which core of a multi-core processor is performing a data transaction corresponding to the cache tag 300.

FIG. 4 illustrates pseudocode representative of example instructions 400 which, when executed by a processor (e.g., the processor 102 of FIG. 1), cause the processor 102 to perform a data transaction and commit a data transaction to non-volatile memory. The example instructions 400 of FIG. 4 may be implemented by an application to interact with an application program interface (API) of an operating system that provides ordering and/or atomicity to data transactions in NVRAM. In some examples, the operating system provides functions including:

heap_open(id): given a 64-bit heap identifier, heap_open returns a heap descriptor (hd);

mmap: the heap is mapped in the process address space using the standard mmap system call. If the MAP_HEAP flag is not specified, no atomicity, durability or ordering guarantees will be provided for heap updates (e.g., the heap is mapped just like regular memory);

heap_commit(hd, address, length, mode): commits pending write-backs made to the heap referenced by hd, in the page range (address: address+length). The changes do not include changes in the write-combine buffer. The mode parameter can have zero or more of the following values:

HEAP_ORDER: the call delimits an epoch. Epoch guarantees will be provided for the updates in the specified page range, but not for updates outside the range;

HEAP_ATOMIC: the updates are committed (e.g., written-back to NVRAM, made persistent) atomically, and the atomic groups are committed in order. It is not necessarily the case that the updates are durable when the call returns;

HEAP_DURABLE: updates are durable (e.g., will be persistent) when the function returns;

munmap: the standard munmap call is also used to unmap persistent heap pages. Pending write-backs are lost (e.g., are not written-back to NVRAM); and

heap_close(hd): closes the heap identified by hd. Uncommitted changes are lost (e.g., are not written-back to NVRAM).

Turning to the example of FIG. 4, the instructions 400 open a heap and map the heap to memory (lines 402, 404). For example, lines 402, 404 map an address space for an application to a memory such as the NVRAM 104 of FIG. 1. The application initiates a data transaction at line 406 using the heap, and writes to the mapped area in line(s) 408. When line 406 occurs, the example counter assigner 226 selects a free counter (e.g., the counter 232) from the set of counters 110 of FIGS. 1 and 2. The counter manager 228 (e.g., in the operating system) is provided with the identifier of the selected counter 210, and tags cache lines 202-208 that are written to as a result of the data transaction.

An example write to the heap is illustrated in line 408, in which the application writes a number to a location within the address space (which is mapped to the memory). Writes to the heap result in writing data to a cache memory (e.g., the cache memory 106 of FIGS. 1 and 2). As data is written to a cache line 202-208 in the cache memory 106, the example counter manager 228 increments the selected counter 210 and tags the cache line(s) 202-208 that are written by the data transaction (e.g., the line(s) 408). Additionally, as the data transaction writes data to the cache lines 202-208 (causing the counter manager 228 to increment the counter 210), the example cache lines 202-208 may be written-back to the NVRAM 104 in accordance with a cache replacement policy. When a cache line 202-208 having data written due to the line(s) 408 is written-back to the NVRAM 104, the counter manager 228 decrements the selected counter 210.

At line 410, after the example application has performed the data writes of line(s) 408, the instructions 400 end the data transaction by committing the data transaction to the NVRAM 104. In the example of FIG. 4, the instructions 400 specify that committing the data transaction is to be performed atomically and in order. Therefore, the example transaction committer 236 determines whether the selected counter 210 is equal to zero (e.g., the data written to the cache memory 106 by line(s) 408 has been written-back to the NVRAM 104 and is, thus, “clean”), that the data transaction is complete, and that any data transactions ahead of the data transaction in order have been committed. If these conditions have been met, the example transaction committer 236 commits the transaction atomically (e.g., by remapping an address space of the application to a shadow page) and frees the counter 210 (e.g., places the counter at the unused or free state).

In some examples in which the transaction committer 236 determines that the counter 210 is not equal to zero (e.g., not all of the cache lines 202-208 that have been written to have been written-back to NVRAM 104), the example transaction committer 236 may determine that a forced flush is to be performed. In some such examples, the transaction committer 236 may force the cache line flusher 230 to flush data transactions that are to be committed prior to the data transaction associated with line(s) 408 to comply with the HEAP_ORDERED flag in line 410.

The example instructions 400 may include additional data transactions in line(s) 412 prior to unmapping the address space (line 414) and closing the heap (line 416).

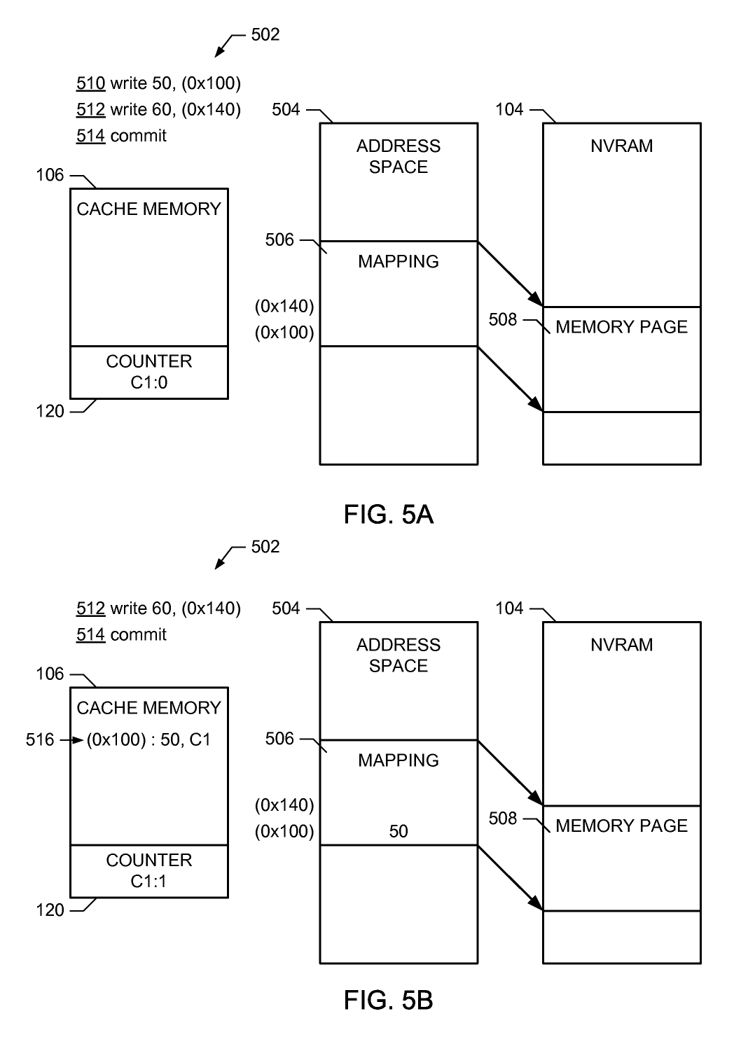

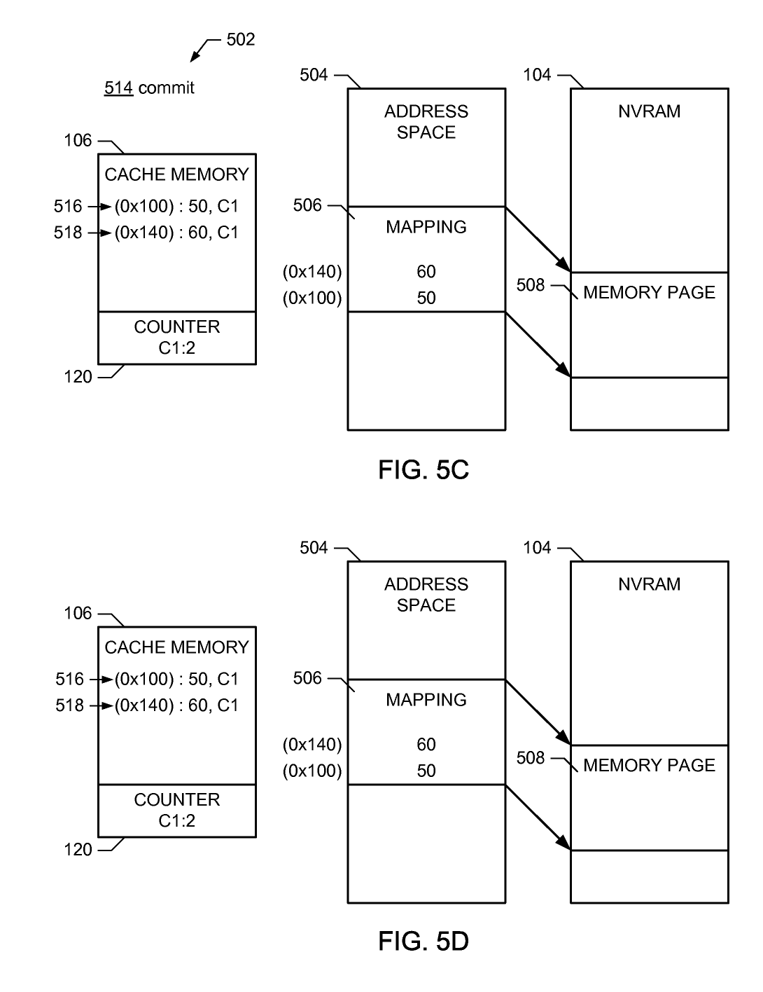

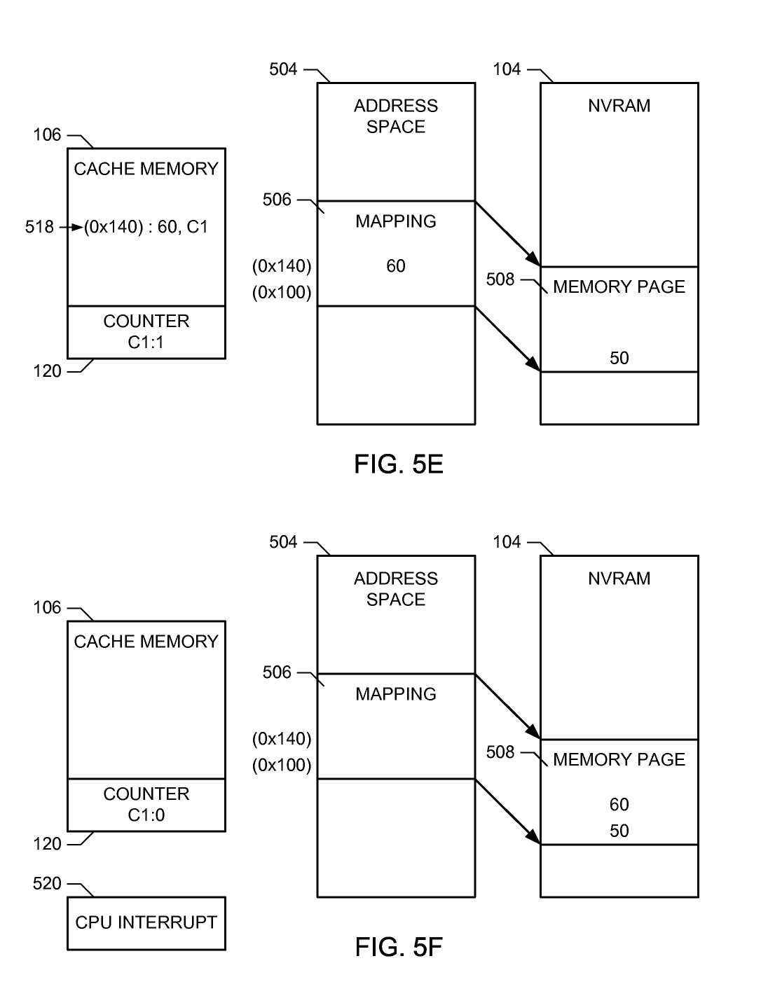

FIGS. 5A-5F illustrate an example process to commit data transactions to non-volatile memory using a processor counter. The example process illustrated in FIGS. 5A-5F may be implemented by the example computing system 100, the example processor 102, the example NVRAM 104, and/or the example memory manager 108 of FIGS. 1 and 2. To illustrate the example process, FIGS. 5A-5F show an instruction set 502 to be performed by a processor (e.g., the processor 102 of FIG. 1), the example NVRAM 104, the example cache memory 106, and an example selected counter 120 from the set of counters 110 of FIG. 1. Additionally, an address space 504 for an application is illustrated. The example address space 504 of FIGS. 5A-5F includes a mapped portion 506 to a corresponding portion 508 of the NVRAM 104. For ease of explanation, each of the example mapping 506 and memory page 508 has a size of one page (e.g., 64 lines of 64 bytes each). In the example of FIGS. 5A-5F, the counter 120 has a counter identifier of “C1.”

In the example of FIG. 5A, the example instruction set 502 includes two write instructions 510, 512 and a commit instruction 514 to be executed by the processor 102. The example instruction set 502 of FIGS. 5A-5F is representative of a single data transaction, although the data transaction may have more or fewer instructions. The example counter 120 begins with a count (or value) of 0 to represent that there are no dirty cache lines associated with the example data transaction.

In FIG. 5B, the example processor 102 has executed the instruction 510 and has written the value ‘50’ to a cache line 516, which is mapped to a virtual address 0x100. Based on writing to the cache line 516, the example memory manager 108 tags the written cache line 516 with the counter identifier C1 of the counter 120 and increments the counter 120 which, in this example, has a count of 1.

In FIG. 5C, the example processor 102 has executed the instruction 512, and has written the value ‘60’ to a cache line 518, which is mapped to a virtual address 0x140. Based on writing to the cache line 518, the example memory manager 108 tags the written cache line 518 with the counter identifier C1 of the counter 120 and increments the counter 120, which has a count of 2.

In FIG. 5D, the example processor 102 has executed the instruction 514 to commit the data transaction. In the illustrated example, the memory manager 108 determines that the transaction commit is to occur sometime in the future (not immediately, so the memory manager 108 does not cause a forced flush).

In FIG. 5E, the example cache line 516 has been written-back to the NVRAM 104 in the memory page 508. When the write-back occurs, the memory manager 108 of the illustrated example determines the counter identifier to be C1 and decrements the counter 120 corresponding to the counter identifier C1. In this example, the counter 120 has a value of 1 after the decrement.

In FIG. 5F, the example cache line 518 has been written-back to the NVRAM 104 in the memory page 508. When the write-back occurs, the memory manager 108 of the illustrated example determines the counter identifier to be C1 and decrements the counter 120 corresponding to the counter identifier C1. The counter 120 has a value of 0 after the decrement, which causes the processor 102 to throw an interrupt 520. The example interrupt 520 alerts the memory manager 108 and/or the operating system to commit the data transaction. The example memory manager 108 commits the transaction immediately, at a later time based on ordering requirements specified by the application, or at a later time regardless of ordering requirements. The processor 102 and the NVRAM 104 of the illustrated example may use the above-described example process to commit a data transaction to non-volatile memory in an efficient manner.

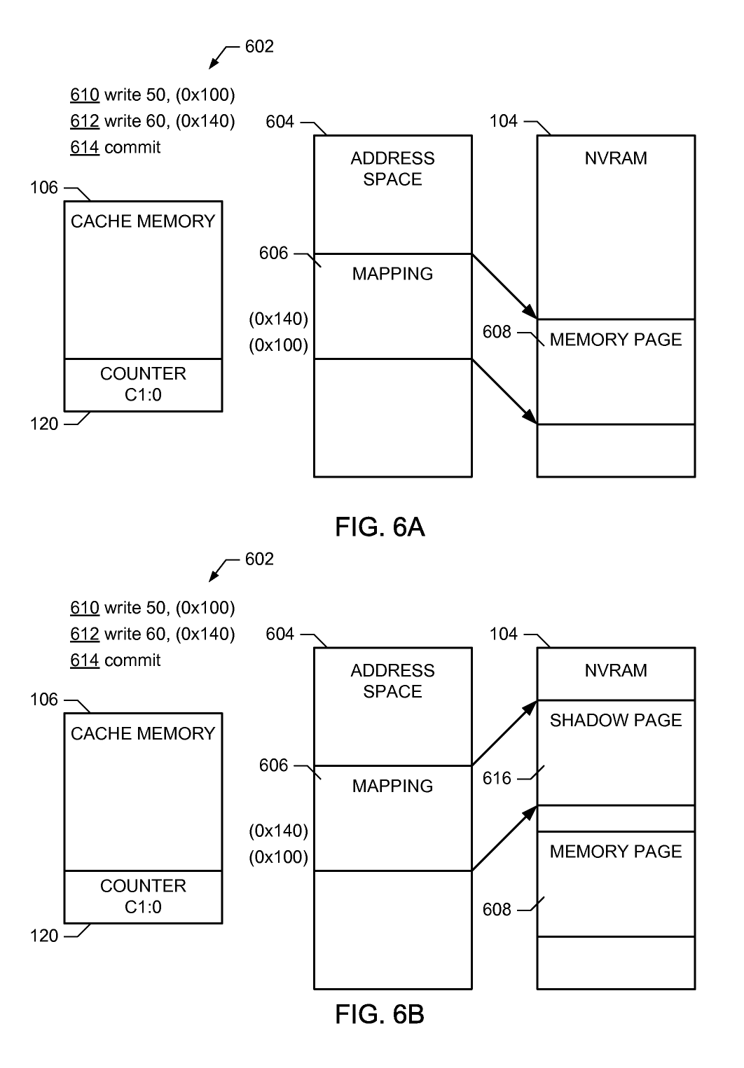

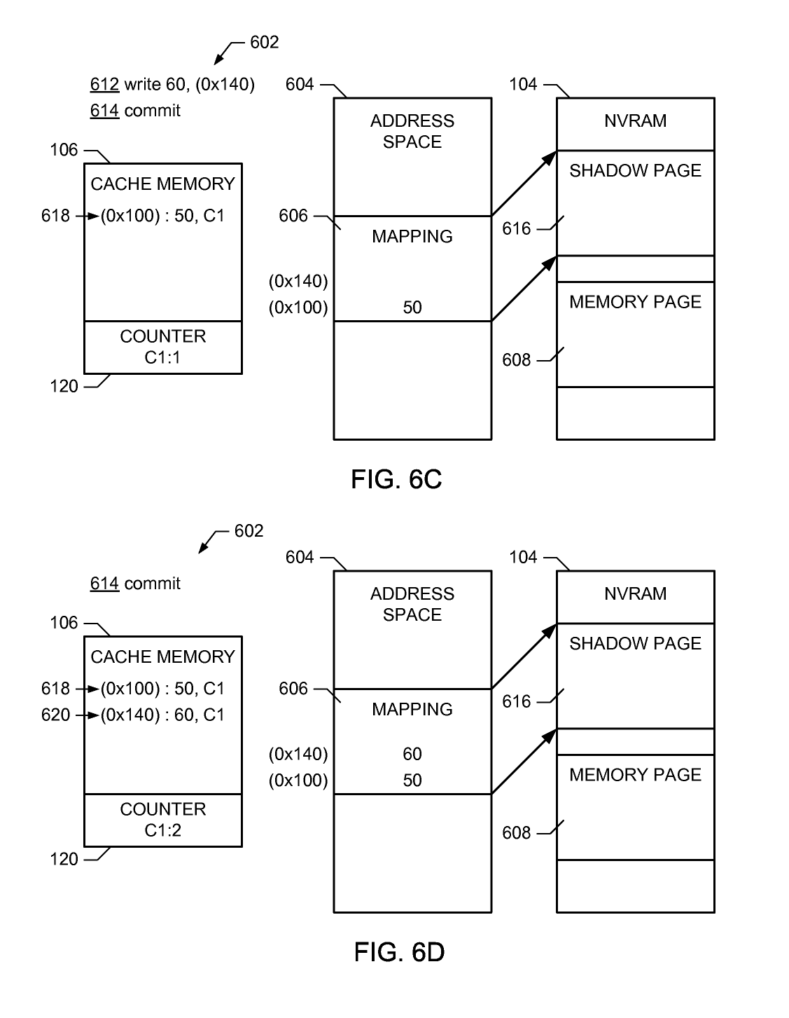

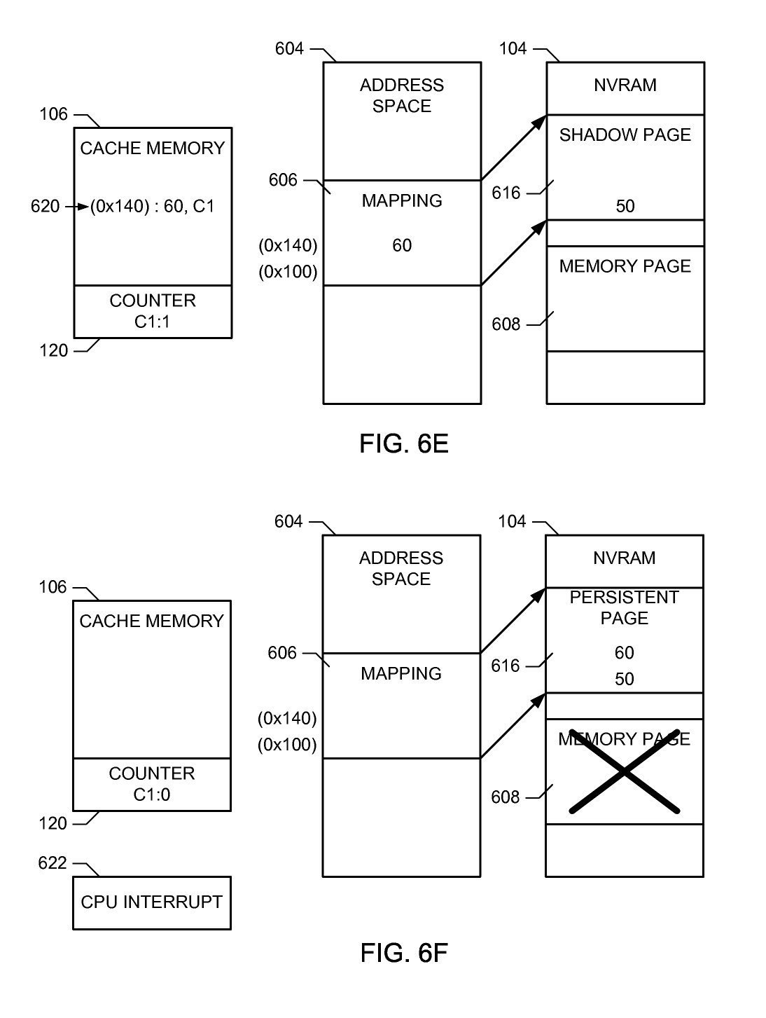

FIGS. 6A-6F illustrate an example process to commit data transactions to non-volatile memory using a processor counter. The example process illustrated in FIGS. 6A-6F may be implemented by the example computing system 100, the example processor 102, the example NVRAM 104, and/or the example memory manager 108 of FIGS. 1 and 2. In contrast to the example process illustrated in FIGS. 5A-5F, the example process illustrated in FIGS. 6A-6F uses shadow paging to commit data transactions to the NVRAM 104. To illustrate the example process, FIGS. 6A-6F show an instruction set 602 to be performed by a processor (e.g., the processor 102 of FIG. 1), the example NVRAM 104, the example cache memory 106, and an example selected counter 120 from the set of counters 110 of FIG. 1. Additionally, an address space 604 for an application is illustrated. The example address space 604 of FIGS. 6A-6F includes a portion 606 mapped to a corresponding portion 608 of the NVRAM 104. For ease of explanation, the example mapped portion 606 and memory page 608 each has a size of one page (e.g., 64 lines of 64 bytes each). In the example of FIGS. 6A-6F, the counter 120 has a counter identifier of “C1.”

In FIG. 6A, the example instruction set 602 includes two write instructions 610, 612 and a commit instruction 614 to be executed by the processor 102. The example instruction set 602 of FIGS. 6A-6F is representative of a single data transaction, although a data transaction may have more or fewer instructions. In the illustrated example, the counter 120 begins with a count of 0 to represent that there are no dirty cache lines associated with the example data transaction.

In the example of FIG. 6B, the example processor 102 has created a shadow page 616 in the NVRAM 104 corresponding to the memory page 608. The example processor 102 further changes the address space mapping 606 to map to the shadow page 616. Thus, when data is exchanged between the processor 102 (e.g., the cache memory 106) and the NVRAM 104, data is written-back to the shadow page 616 instead of to the memory page 608.

In the example of FIG. 6C, the example processor 102 has executed the instruction 610 and has written the value ‘50’ to a cache line 618, which is mapped to a virtual address 0x100. Based on writing to the cache line 618, the example memory manager 108 tags the written cache line 618 with the counter identifier C1 of the counter 120 and increments the counter 120 which, in this example, has a count of 1.

In the example of FIG. 6D, the example processor 102 has executed the instruction 612 and has written the value ‘60’ to a cache line 620, which is mapped to a virtual address 0x140. Based on writing to the cache line 620, the example memory manager 108 tags the written cache line 620 with the counter identifier C1 of the counter 120, and increments the counter 120 which, in this example, now has a count of 2.

In the example of FIG. 6E, the example processor 102 has executed the instruction 614 to commit the data transaction and the example cache line 618 has been written-back to the NVRAM 104 in the shadow page 616. In the illustrated example, the memory manager 108 determines that the transaction commit is to occur sometime in the future (not immediately), so the memory manager 108 does not cause a forced flush. When the write-back of the cache line 618 occurs, the memory manager 108 of the illustrated example determines the counter identifier to be C1 from a cache tag associated with the cache line 618 and decrements the counter 120 corresponding to the counter identifier C1. The counter 120, in this example, now has a value of 1 after the decrement.

In the example of FIG. 6F, the example cache line 620 has been written-back to the NVRAM 104 in the shadow page 616. When the write-back occurs, the memory manager 108 of the illustrated example determines the counter identifier to be C1 from a cache tag associated with the cache line 620 and decrements the counter 120 corresponding to the counter identifier C1. The counter 120, in this example, now has a value of 0 after the decrement, which causes the processor 102 to throw an interrupt 622. The example interrupt 622 alerts the memory manager 108 and/or the operating system to commit the data transaction. The example memory manager 108 commits the data transaction by causing the shadow page 616 to replace the original memory page 608, which causes the shadow page 616 to become a persistent page. As a result, the shadow page 616 becomes the memory page in the NVRAM 104 for subsequent data transactions. The example memory manager 108 commits the transaction (1) immediately, (2) at a later time based on ordering requirements specified by the application, or (3) at a later time regardless of ordering requirements. The processor 102 and the NVRAM 104 of the illustrated example may use the above-described example process to commit a data transaction to non-volatile memory in an efficient manner because the example processor 102 reduces and/or avoids computationally-expensive forced cache flushing.

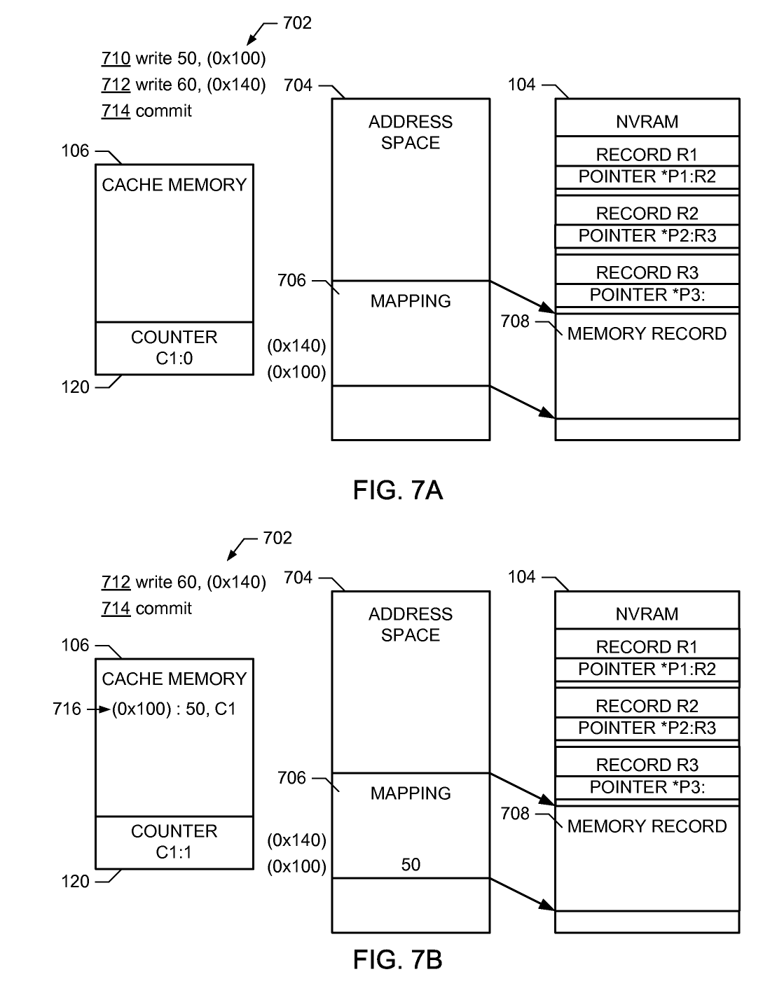

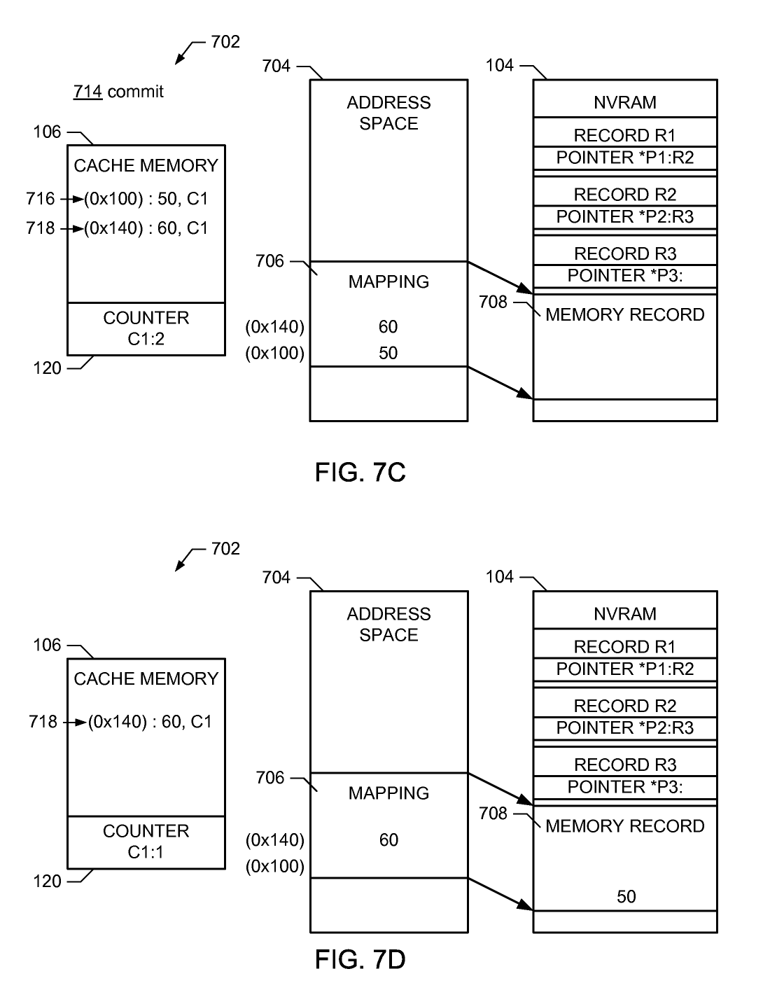

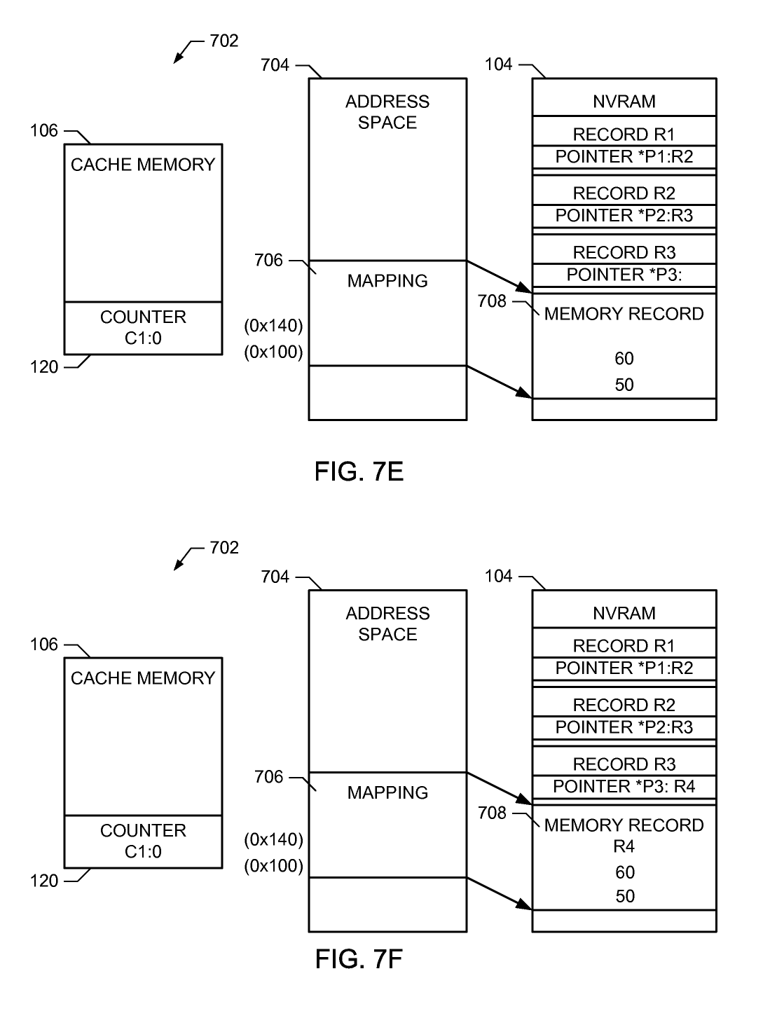

FIGS. 7A-7F illustrate an example process to commit data transactions to non-volatile memory using a processor counter. The example process illustrated in FIGS. 7A-7F may be implemented by the example computing system 100, the example processor 102, the example NVRAM 104, and/or the example memory manager 108 of FIGS. 1 and 2. In contrast to the example processes illustrated in FIGS. 5A-5F and 6A-6F, the example process illustrated in FIGS. 7A-7F uses linked lists memory records to commit data transactions to the NVRAM 104. To illustrate the example process, FIGS. 7A-7F show an instruction set 702 to be performed by a processor (e.g., the processor 102 of FIG. 1), the example NVRAM 104, the example cache memory 106, and an example selected counter 120 from the set of counters 110 of FIG. 1. Additionally, an address space 704 for an application is illustrated. The example address space 704 of FIGS. 7A-7F includes a portion 706 mapped to a corresponding portion (e.g., a memory record 708) of the NVRAM 104. For ease of explanation, the example mapped portion 706 and memory record 708 each has a size of one page (e.g., 64 lines of 64 bytes each). In the example of FIGS. 7A-7F, the counter 120 has a counter identifier of “C1.”

In FIG. 7A, the example instruction set 702 includes two write instructions 710, 712 and a commit instruction 714 to be executed by the processor 102. The example instruction set 702 of FIGS. 7A-7F is representative of a single data transaction, although a data transaction may have more or fewer instructions. In the illustrated example, the counter 120 begins with a count of 0 to represent that there are no dirty cache lines associated with the example data transaction. In addition to the memory record 708, the NVRAM includes records R1, R2, and R3. The records R1, R2, and R3 each have a pointer *P1, *P2, and *P3. The first record R1 in the NVRAM 104 has a pointer *P1, which has a pointer value that points to the subsequent record R2 in the NVRAM 104. Similarly, the pointer *P2 of the record R2 points to the subsequent record R3. In contrast, the pointer *P3 of the record R3 does not have a value, or has a null or arbitrary value, because the record R3 is considered the final record in the NVRAM 104.

In the example of FIG. 7B, the example processor 102 has executed the instruction 710 and has written the value ‘50’ to a cache line 716, which is mapped to a virtual address 0x100. Based on writing to the cache line 716, the example memory manager 108 tags the written cache line 716 with the counter identifier C1 of the counter 120 and increments the counter 120 which, in this example, has a count of 1.

In the example of FIG. 7C, the example processor 102 has executed the instruction 712 and has written the value ‘60’ to a cache line 718, which is mapped to a virtual address 0x140. Based on writing to the cache line 718, the example memory manager 108 tags the written cache line 718 with the counter identifier C1 of the counter 120, and increments the counter 120 which, in this example, now has a count of 2.

In the example of FIG. 7D, the example processor 102 has executed the instruction 714 to commit the data transaction and the example cache line 716 has been written-back to the NVRAM 104 in the memory record 708. In the illustrated example, the transaction committer 236 determines that the transaction commit is to occur sometime in the future (e.g., not immediately), so the memory manager 108 (e.g., the cache line flusher 230) does not cause a forced flush. When the write-back of the cache line 716 occurs, the memory manager 108 of the illustrated example determines the counter identifier to be C1 from a cache tag associated with the cache line 716 and decrements the counter 120 corresponding to the counter identifier C1. The counter 120, in this example, now has a value of 1 after the decrement.

In the example of FIG. 7E, the example cache line 718 has been written-back to the NVRAM 104 in the memory record 708. When the write-back occurs, the memory manager 108 of the illustrated example determines the counter identifier to be C1 from a cache tag associated with the cache line 718 and decrements the counter 120 corresponding to the counter identifier C1. As a result, the value of the counter 120 is 0.

In the example of FIG. 7F, the transaction committer 236 has polled the value of the counter 120 and determined that the value is 0. The value of the counter 120 being 0 is one condition, of which there may be more, for the transaction committer 236 to commit the data transaction. In the example of FIG. 7F, the cache line flusher 230 has written-back the data associated with the data transaction to the memory record 708. To commit the transaction, the example transaction committer 236 changes the value of the pointer in the preceding record R3 to point to the memory record 708 (e.g., record R4). As a result, other processes and/or applications recognize the memory record 708 as a persistent record in the NVRAM 104. The processor 102 and the NVRAM 104 of the illustrated example may use the above-described example process to commit a data transaction to non-volatile memory in an efficient manner because the example processor 102 reduces and/or avoids computationally-expensive forced cache flushing.

While an example processor 102 has been illustrated in FIGS. 1 and 2, one or more of the blocks, registers, counters, tags, cache memories, non-volatile memories, elements, processes and/or devices illustrated in FIGS. 1 and 2 may be combined, divided, re-arranged, omitted, eliminated and/or implemented in any way. Further, the example memory manager 108, the example counter(s) 210-216, the example counter assigner 226, the example counter manager 228, the example cache line flusher 230, the example application 232, the example operating system 234, the example transaction committer 236, the example offset recorder 238 and/or, more generally, the example processor 102 may be implemented by hardware, software, firmware and/or any combination of hardware, software and/or firmware. Thus, for example, any of the example memory manager 108, the example counter(s) 210-216, the example counter assigner 226, the example counter manager 228, the example cache line flusher 230, the example application 232, the example operating system 234, the example transaction committer 236, the example offset recorder 238 and/or, more generally, the example processor 102 could be implemented by one or more circuit(s), programmable processor(s), application specific integrated circuit(s) (ASIC(s)), programmable logic device(s) (PLD(s)) and/or field programmable logic device(s) (FPLD(s)), etc., on one or more substrates or chips.

When any apparatus or system claim of this patent is read to cover a purely software and/or firmware implementation, at least one of the example memory manager 108, the example counter(s) 210-216, the example counter assigner 226, the example counter manager 228, the example cache line flusher 230, the example application 232, the example operating system 234, the example transaction committer 236, and/or the example offset recorder 238 are hereby expressly defined to include a tangible computer readable medium such as a memory, DVD, CD, etc. storing the software and/or firmware. Further still, the example processor 102 and/or the example memory manager 108 may include one or more elements, processes and/or devices in addition to, or instead of, those illustrated in FIG. 2, and/or may include more than one of any or all of the illustrated elements, processes and devices.

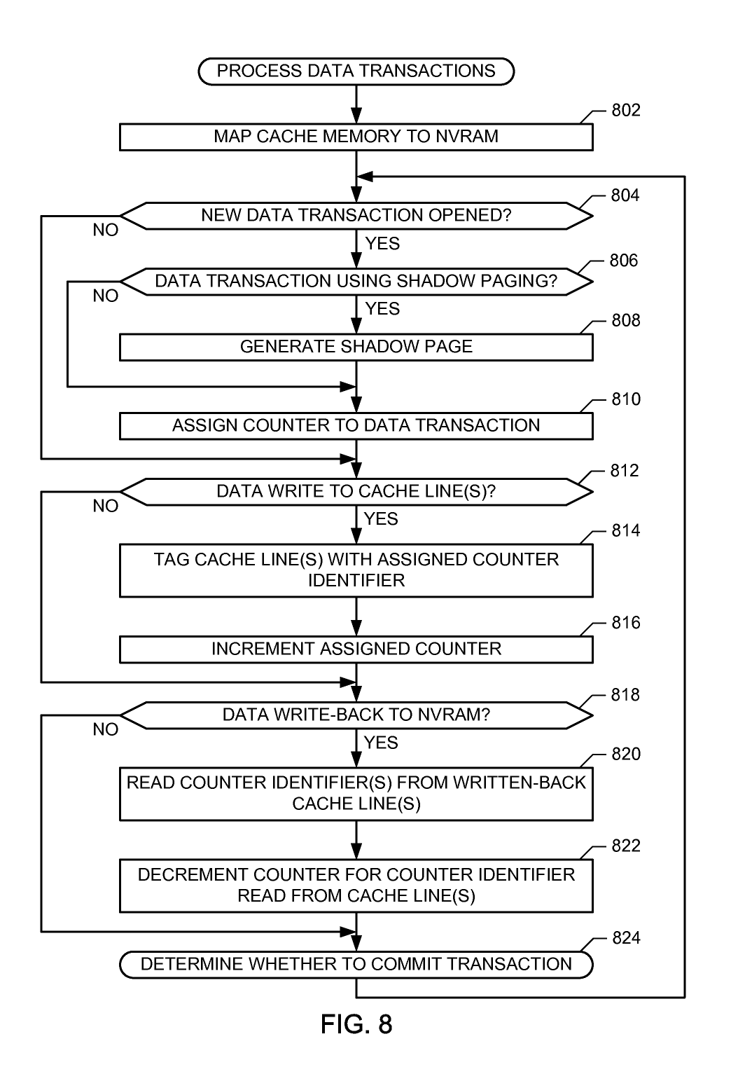

FIGS. 8, 9, and 10 depict example flow diagrams representative of processes that may be implemented using, for example, computer readable instructions that may be used to commit data transactions to non-volatile memory. The example processes of FIGS. 8, 9, and 10 may be performed using a processor, a controller and/or any other suitable processing device. For example, the example processes of FIGS. 8, 9, and 10 may be implemented using coded instructions (e.g., computer readable instructions) stored on a tangible computer readable medium such as a flash memory, a read-only memory (ROM), and/or a random-access memory (RAM). As used herein, the term tangible computer readable medium is expressly defined to include any type of computer readable storage and to exclude propagating signals. The example processes of FIGS. 8, 9, and 10 may be implemented using coded instructions (e.g., computer readable instructions) stored on a non-transitory computer readable medium such as a flash memory, a read-only memory (ROM), a random-access memory (RAM), a cache, or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

Alternatively, some or all of the example processes of FIGS. 8, 9, and 10 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIGS. 8, 9, and 10 may be implemented manually or as any combination(s) of any of the foregoing techniques, for example, any combination of firmware, software, discrete logic and/or hardware. Further, although the example processes of FIGS. 8, 9, and 10 are described with reference to the flow diagrams of FIGS. 8, 9, and 10, other methods of implementing the processes of FIGS. 8, 9, and 10 may be employed. For example, the order of execution of the blocks may be changed, and/or some of the blocks described may be changed, eliminated, sub-divided, or combined. Additionally, any or all of the example processes of FIGS. 8, 9, and 10 may be performed sequentially and/or in parallel by, for example, separate processing threads, processors, devices, discrete logic, circuits, etc.

FIG. 8 is a flowchart representative of example machine readable instructions 800 which may be executed by the example processor 102 and/or the example memory manager 108 of FIG. 1 to perform data transactions. In some examples, the instructions 800 of FIG. 8 begin when an application is allotted a portion of a cache memory in a processor (e.g., one or more lines of the cache memory 106 in the processor 102 of FIG. 1) (block 802). The example processor 102 determines (e.g., by executing computer-readable instructions associated with an application or an operating system) whether a new data transaction is to be opened (e.g., a call to a heap_begin( ) function) (block 804). The example application may open a data transaction to, for example, achieve atomicity and/or ordering guarantees from the operating system for a set of instructions and/or data operations to be stored to a non-volatile memory (e.g., the NVRAM 104 of FIG. 1).

If a data transaction has been opened (block 804), the example memory manager 108 determines whether the data transaction is using shadow paging (block 806). If the data transaction is using shadow paging (block 806), the example memory manager generates a shadow page (e.g., a copy of a persistent page) in the NVRAM 104 (block 808). In some examples, the shadow page is used to effect atomicity and/or ordering in the data transaction. After generating the shadow page (block 808) or if the data transaction is not using shadow paging (block 806), the example memory manager 108 (e.g., via the counter assigner 226) assigns a counter to the data transaction (block 810). For example, the counter assigner 226 may determine which counters in the set of counters 110 are free (e.g., not assigned to a data transaction).

After assigning the counter to the new data transaction (block 810) or if no new data transactions have been opened (block 804), the memory manager 108 (e.g., via the counter manager 228) determines whether a data write to one or more cache line(s) (e.g., the cache line(s) 202-208) has occurred (block 812). If a data write has occurred (block 812), the example counter manager 228 tags the cache line(s) 202-208 with a counter identifier of the assigned counter (block 814). The example counter manager 228 also increments the assigned counter (block 816).

After incrementing the assigned counter (block 816) or if there has not been a data write (block 812), the example counter manager 228 determines whether the cache line flusher 230 has written-back data to the NVRAM 104 (block 818). If the cache line flusher 230 has written-back data (block 818), the example counter manager 228 reads the counter identifier(s) from the written-back cache line(s) (block 820). For example, the counter manager 228 may read the counter identifier field 302 from a cache tag associated with a written-back cache line. The example counter manager 228 also decrements the counter associated with the counter identifier read from the written-back cache line(s) (block 822).

After decrementing the counter (block 822) or if there has not been a data write-back to the NVRAM 104 (block 818), an application (e.g., via the transaction committer 238) determines whether to commit the data transaction (block 824). An example implementation of block 824 is described below in conjunction with FIG. 9. After determining whether to commit a data transaction and/or committing a data transaction (block 824), control returns to block 802 to iterate the example instructions 800.

FIG. 9 is a flowchart representative of example machine readable instructions 900 which may be executed by the example transaction committer 238 and/or the example application 232 of FIG. 2 to commit a data transaction to non-volatile memory (e.g., the NVRAM 104 of FIG. 1). In some examples, committing the transaction is performed via instructions performed by the processor 102. The example instructions 900 may be used to implement block 724 of FIG. 7 to determine whether to commit a data transaction and/or to commit a data transaction.

The example instructions 900 begin by determining (e.g., via the transaction committer 238 of FIG. 2) whether a data transaction has been completed (block 902). For example, the transaction committer 238 may poll the counter(s) 210-216 to determine whether the value(s) of the counters 210-216 are equal to the threshold (e.g., 0), and/or an interrupt may be issued by the example counter manager 228 of FIG. 2. If no data transactions have been completed (block 902), the example instructions 900 end and control returns to the example instructions 700 of FIG. 7. On the other hand, if a data transaction has ended (block 902), the example transaction committer 238 determines whether the counter assigned to the data transaction is equal to a threshold value (block 904). For example, the transaction committer 238 may determine whether the counter in question is equal to 0 to represent that no dirty cache lines exist for the data transaction. In other words, a threshold value of 0 represents that the data transaction may be committed when, in addition to other criteria, the cache lines associated with the counter are not storing any data for the data transaction that has not been committed to NVRAM 104.

If the assigned counter is equal to the threshold value (block 904), the transaction committer 238 further determines whether any ordering constraints associated with the data transaction have been satisfied (block 906). If the assigned counter value is not equal to the threshold value (block 904), or if ordering constraints have not been satisfied (block 906), the example transaction committer 238 further determines whether a cache flush is needed (block 908). For example, a cache flush may be forced if a data transaction has been uncommitted for longer than a threshold time. If a cache flush is not needed (block 908), the example instructions 900 may end without committing a data transaction.

On the other hand, if a cache flush is to be performed (block 908), the example offset recorder 238 flushes the cache memory from a stored offset to the end of the dirty cache lines (block 910). For example, the offset recorder 238 stores an offset (e.g., a cache line identifier, a number of lines from the beginning of a cache memory, etc.) at which the writes to the cache memory 106 were started by the data transaction. As the dirty cache lines are flushed, the example counter manager 228 decrements the assigned counter for the data transaction. When the offset recorder 238 determines that the assigned counter is equal to the threshold value (e.g., 0), the example offset recorder 238 stops the flushing.

After flushing the cache (block 910) and/or if the ordering constraints are satisfied (block 904), the example transaction committer 238 commits the data transaction associated with the assigned counter (block 912). In some examples, the instructions 900 iterate to commit multiple data transactions. After committing or failing to commit the data transactions, control returns to the example instructions 900 of FIG. 9.

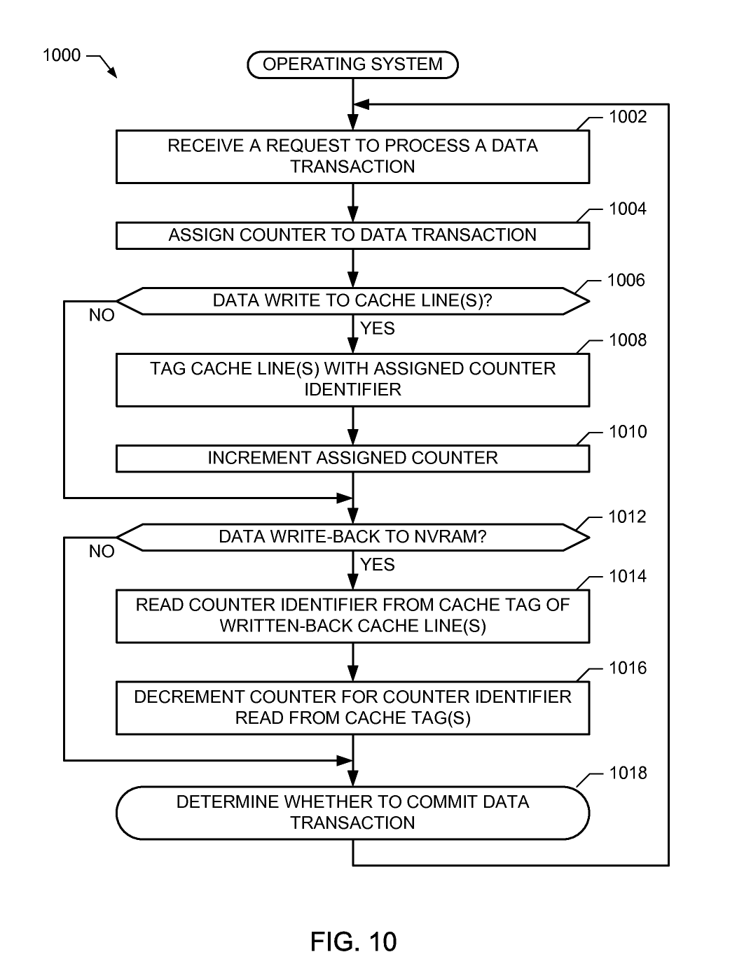

FIG. 10 is a flowchart representative of example machine readable instructions 1000 which may be executed by the example processor 102, a circuit, and/or an example operating system to provide an interface to a computer application for operating on data in a non-volatile memory (e.g., the NVRAM 104 of FIG. 1). The example instructions 1000 begin by receiving (e.g., at an operating system via the example counter assigner 226 of FIG. 2) a request to process a data transaction (block 1002). The example operating system (e.g., via the counter assigner 226) assigns a counter to the data transaction (block 1004).

The example operating system (e.g., via the counter manager 228 of FIG. 2) determines whether there is a data write to one or more cache lines (block 1006). If a data write has occurred (block 1006), the example operating system (e.g., via the counter manager 228) tags the cache line(s) to which the data was written with a counter identifier of the assigned counter (block 1008). The example processor 102 increments the assigned counter (block 1010).

After incrementing the assigned counter (block 1010) or if a data write has not occurred (block 1006), the example operating system (e.g., via the counter manager 228) determines whether there is a data write-back from the cache line(s) to the NVRAM 104 (block 1012). If there is a data write-back (block 1012), the example operating system (e.g., via the counter manager 228) reads a counter identifier from a cache tag associated with the cache line(s) that were written-back to the NVRAM 104 (block 1014). The example processor 102 (e.g., via the counter manager 228) decrements the counter based on the counter identifier read from the cache tag(s) (block 1016).

After decrementing the counter (block 1016) or if no write-backs to the NVRAM 104 have occurred (block 1018), the example operating system and/or an application (e.g., via the transaction committer 236) determines whether to commit the data transaction (block 1018). Example instructions to implement block 1018 is described above in conjunction with FIG. 9. After determining whether to commit the data transaction (block 1018), the example instructions 1000 of FIG. 10 iterate to process additional data transactions received at the operating system.

In some examples, blocks 1006-1010 and/or blocks 1012-1016 are repeated for the data writes to the cache memory 106 and/or for the data write-backs from the cache memory 106 to the NVRAM 104 of FIG. 1. Additionally, because some data transactions may be started before prior data transactions have been committed, the instructions 1000 of FIG. 10 may be run in multiple instances for the multiple data transactions. In this manner, an operating system may control the use, operation, and/or assignment of the example set of counters 110 of FIGS. 1 and 2.

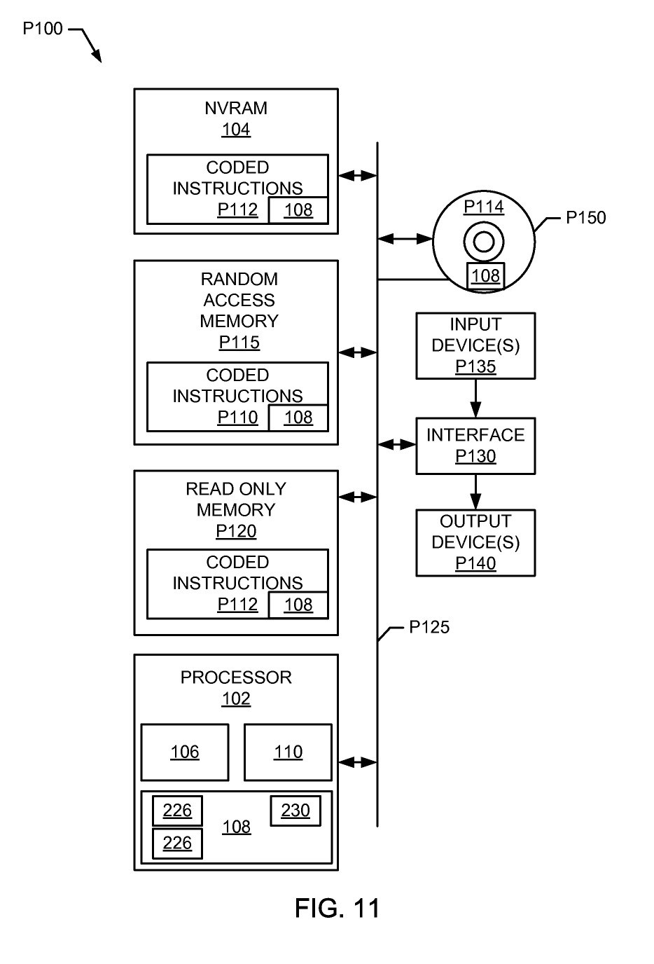

FIG. 11 is a schematic diagram of an example processor platform P100 that may be used and/or programmed to execute the example machine readable instructions 800, 900, and/or 1000 of FIGS. 8, 9, and/or 10. One or more general-purpose processors, processor cores, microcontrollers, etc may be used to implement the processor platform P100.

The processor platform P100 of FIG. 11 includes at least one programmable processor 102. The processor 102 may implement, for example, the example cache memory 106, the example counter(s) 110, the example counter assigner 226, the example counter manager 228, the example cache line flusher 230, the example application 232, the example operating system 238, the example transaction committer 236, the example offset recorder 238 and, more generally, the example memory manager 108 of FIG. 2. For example, the example cache memory 106 includes example cache lines 114, 116, 118 and temporarily stores data in at least one cache line 114, 116, 118, where the data is associated with a data transaction. At least one of the example counter(s) 110 (e.g., the counter 120) is to be incremented in response to a data write to the at least one cache line 114, 116, 118 and is to be decremented in response to a write-back of the data from the at least one cache line 114, 116, 118 to NVRAM 104. Additionally, the example memory manager 108 selectively associates the counter 120 with the at least one cache line 114, 116, 118 to commit the data transaction when a value in the counter is equal to a threshold value.

The processor 102 executes coded instructions P110 and/or P112 present in main memory of the processor 102 (e.g., within a RAM P115 and/or a ROM P120) and/or stored in the tangible computer-readable storage medium P150. The processor 102 may be any type of processing unit, such as a processor core, a processor and/or a microcontroller. The processor 102 may execute, among other things, the example interactions and/or the example machine-accessible instructions 800, 900, and/or 1000 of FIGS. 8, 9, and/or 10 to migrate virtual machines, as described herein. Thus, the coded instructions P110, P112 may include the instructions 800, 900, and/or 1000 of FIGS. 8, 9, and/or 10.

The processor 102 is in communication with the main memory (including a ROM P120, the RAM P115, and/or the NVRAM 104) via a bus P125. The RAM P115 may be implemented by dynamic random access memory (DRAM), synchronous dynamic random access memory (SDRAM), and/or any other type of RAM device, and ROM may be implemented by flash memory and/or any other desired type of memory device. In some examples, the NVRAM 104 replaces the RAM P115 as the random access memory for the processing platform P100. The tangible computer-readable memory P150 may be any type of tangible computer-readable medium such as, for example, compact disk (CD), a CD-ROM, a floppy disk, a hard drive, a digital versatile disk (DVD), and/or a memory associated with the processor 102. Access to the NVRAM 104, the memory P115, the memory P120, and/or the tangible computer-medium P150 may be controlled by a memory controller. In some examples, the coded instructions P110 are part of an installation pack and the memory is a memory from which that installation pack can be downloaded (e.g., a server) or a portable medium such as a CD, DVD, or flash drive. In some examples, the coded instructions are part of installed software in the NVRAM 104, the RAM P115, the ROM P120, and/or the computer-readable memory P150.

The processor platform P100 also includes an interface circuit P130. Any type of interface standard, such as an external memory interface, serial port, general-purpose input/output, etc, may implement the interface circuit P130. One or more input devices P135 and one or more output devices P140 are connected to the interface circuit P130.

The example memory manager 108 and/or any portion of the memory manager 108 of FIGS. 1 and 2 may be implemented using the processor 102 and/or the coded instructions P110, P112, P114, P114, stored on any one or more of the computer readable memory P150, the memories P115, P120, and/or the NVRAM 104.

Example methods, apparatus, and/or articles of manufacture disclosed herein provide atomicity and/or ordering of data transactions when the committing data transactions to non-volatile memory. Example methods, apparatus, and/or articles of manufacture disclosed herein use shadow paging to provide atomicity and/or ordering to data transactions. Example methods, apparatus, and/or articles of manufacture disclosed herein update an entry in main memory to commit a data transaction. In contrast to known methods of providing atomicity and ordering for non-volatile memory, example methods, apparatus, and/or articles of manufacture disclosed herein reduce or eliminate flushing of cache lines beyond the normal cache line replacement policy, thereby improving performance of the processor. Additionally, example methods, apparatus, and/or articles of manufacture implement fewer and/or less extensive modifications to processor hardware and/or memory than known methods. Example methods, apparatus, and/or articles of manufacture disclosed herein use processor operations that can be implemented efficiently, reducing or avoiding latency overhead. Example methods, apparatus, and/or articles of manufacture may also function in combination with multi-core processors and/or multitasking operating systems because the different transactions in different threads of execution will use different counters and, thus, will not interfere with each other.

Although certain methods, apparatus, systems, and articles of manufacture have been described herein, the scope of coverage of this patent is not limited thereto. To the contrary, this patent covers all methods, apparatus, and articles of manufacture fairly falling within the scope of the claims of this patent.

What is claimed is:

1. A method of managing memory, comprising:
mapping a cache memory to a random access memory (RAM);
incrementing a counter in response to a data write to a cache line of the cache memory;
decrementing the counter in response to a write-back of the data from the cache line; and
committing the data to the RAM when the counter is equal to a threshold.

2. A method as defined in claim 1, further comprising generating a shadow page in the RAM corresponding to the mapping, the write-back of the data being a write-back to the shadow page.

3. A method as defined in claim 2, wherein committing the data comprises converting the shadow page to a persistent page.

4. A method as defined in claim 1, further comprising assigning the counter to a transaction associated with the data write.

5. A method as defined in claim 1, further comprising tagging the cache line with an identification of the counter.

6. A method as defined in claim 1, wherein decrementing the counter comprises reading a tag associated with the cache line to determine an identifier of the counter.

7. A method as defined in claim 1, further comprising notifying an operating system when the counter is equal to the threshold.

8. A method as defined in claim 7, wherein the threshold is representative of zero cache lines storing data associated with a data transaction that has not been written-back to the RAM.

9. A method as defined in claim 1, wherein the RAM is a non-volatile RAM (NVRAM).

10. An apparatus to manage memory, comprising:
a cache having a cache line to store data associated with a data transaction;
a counter to be incremented in response to a data write to the cache line and to be decremented in response to a write-back of the data from the cache line to a random access memory (RAM); and
a memory manager to selectively associate the counter with the cache line and to commit the transaction when a value in the counter is equal to a threshold.

11. An apparatus as defined in claim 10, wherein the memory manager comprises a counter assigner to assign the counter to the transaction.

12. An apparatus as defined in claim 10, wherein the memory manager comprises a counter manager to, when first data is written to the cache line, tag the cache line with an identifier of the counter and increment the counter.

13. An apparatus as defined in claim 12, wherein the counter manager is to, when second data in the cache line is written back to the RAM, read a tag from the second data and to decrement the counter corresponding to the tag.

14. An apparatus as defined in claim 10, wherein the cache comprises a plurality of lines, the counter being one of a plurality of counters, a number of the counters being equal to or greater than a number of the lines.

15. An apparatus as defined in claim 10, wherein the memory manager is to communicate with a transaction committer to commit the transaction to the RAM in response to at least one of receiving an interrupt representative of the counter being equal to the threshold, determining that the transaction is older than a time limit, or determining that the counter is equal to the threshold by polling the counter.

16. An apparatus as defined in claim 15, wherein the memory manager is to communicate with an offset recorder to record an offset of a cache line with respect to a page start location, the transaction committer to flush the cache beginning at the offset.

17. An apparatus as defined in claim 10, further comprising a cache tag associated with the cache line, the cache tag to store an identifier of the counter.

18. An apparatus as defined in claim 10, wherein the RAM is a non-volatile random access memory (NVRAM).

19. A tangible article of manufacture comprising machine readable instructions which, when executed, cause a machine to at least:
assign a counter to a data transaction;
tag first data to be written to a cache line with second data representative of the counter assigned to the data transaction; and
in response to an indication that the counter is equal to a threshold value, commit the data transaction to a random access memory (RAM).

20. An article of manufacture as defined in claim 19, wherein the instructions are further to cause the machine to at least read a counter identifier from a cache tag associated with a cache line from which data is written-back to the RAM.

21. An article of manufacture as defined in claim 20, wherein the instructions are further to cause the machine to decrement the counter associated with the counter identifier when data from the cache line is written-back to the RAM.

22. An article of manufacture as defined in claim 21, wherein committing the transaction is based on at least one of the data transaction being completed or an ordering constraint being satisfied.

23. An article of manufacture as defined in claim 19, wherein the RAM is a non-volatile random access memory (NVRAM).

24. An article of manufacture as defined in claim 19, wherein the instructions are further to cause the machine to at least update third data in the RAM to point to data associated with the data transaction that is written-back to the RAM.
